(19) United States
(12) Patent Application Publication
(10) Pub. No.: US 2008/0068176 A1
(43) Pub. Date: Mar. 20, 2008

(54) RFID inlay structure

(75) Inventors: Junji Azuma, Elk Grove Village, IL (US); Yoji Takehiro, Nagaokakyo-shi (JP)

Correspondence Address: DICKSTEIN SHAPIRO LLP, 1825 EYE STREET NW, Washington, DC, 20006-5403, US

(73) Assignee: OMRON CORPORATION, Kyoto (JP)

(21) Appl. No.: 11/898,888

(22) Filed: Sep. 17, 2007

Related U.S. Application Data
(60) Provisional application No. 60/844,684, filed on Sep. 15, 2006.

(51) Int. Cl. G08B 13/14

(52) U.S. Cl. 340/572.7; 340/572.8

(57) ABSTRACT

Embodiments of the invention provide RFID inlay structures that can be written to and read from more than one direction. Embodiments of the invention also include RFID inlay structures constructed such that adjacent inlays doe not touch one another, even when adjacent, underlying object are in close proximity.

### REFERENCE TO RELATED APPLICATIONS

This application claims priority benefit under 35 U.S.C. §119(e) of provisional Application No. 60/844,684 filed Sep. 15, 2006.

### BACKGROUND

1. Technical Field

The invention relates generally to integrated circuits used in non-contact reading of information recorded on a recording medium, and more specifically, to the structure and placement of RFID tags on objects.

2. Discussion of Background Technology

Radio frequency identification (RFID) systems are becoming an increasingly popular technology for storing and remotely retrieving data, such as identification information, from objects. A common application for RFID technology is a retail store, where information related to each piece of merchandise, such as a product code or the price of the product, is stored and can easily be read out by scanning an RFID tag on the product, as described in more detail below. In the retail environment, RFID technology is useful for sales transactions, preventing thefts of unpurchased merchandise, as well as for inventory control. The applications of RFID technology in the supply chain is limitless. In addition, other known applications for RFID technology include identification of persons and animals as well as certain forms of electronic payment.

In an RFID system, an RFID inlay—also known as an RFID transponder or RFID tag—is attached to an object. The RFID inlay includes an integrated circuit chip connected to a radio frequency antenna, which may include a looped antenna for high frequency (HF) applications or a solid antenna for ultra high frequency (UHF) applications. The integrated circuit chip functions as a digital memory, storing data on the underlying object. A second component of the RFID system is an RFID reader, which sends and receives signals from the RFID inlay to extract data that is stored in the chip within the inlay. An RFID encoder, which may or may not be within the same device as the RFID reader, is used to write information to the RFID inlay.

FIG. 1A shows a three-dimensional object 11, e.g., a product container, having a base 15, a front face 11B, a side face 11A (not shown), and opposite side face 11C, and a top portion 16. The object 11 also has a product label 12 with a conventional RFID inlay structure 10, adhered thereto. FIG. 1B shows the product label 12 prior to attachment on the three-dimensional object 11. As shown in FIG. 1B, the product label 12 has three sections 12A-C. In use, the three sections 12A-C are respectively adhered to the first side face 11A, the front face 11B, and the second side face 11C of the object 11. With this exemplary arrangement, the front face section 12B of the product label 12 has a conventional RFID inlay 10 thereon. Within the RFID inlay 10 is an integrated circuit chip 13 which includes a memory for storing data about the underlying object 11 and/or its contents.

One drawback associated with the conventional RFID inlay 10 is that, for purposes of reading from and writing to, it is only sensitive from one direction, i.e., from the front face section 12B of the label in the example shown in FIG. 1A. As such, an RFID reader or encoder must approach the object 11 from the front in order to ensure that data is properly read from or written to the chip 13.

Accordingly, there is a need for RFID inlays that can be easily written to or read out from more than one direction. In addition, it is desirable to have the RFID inlay constructed such that many objects having the RFID inlays can be arranged in close proximity or in contact with one another with minimal interference during the data transmission.

### SUMMARY

Embodiments of the invention provide an RFID inlay structure that can be attached to more than one side of an object. In one embodiment, when the RFID inlay is placed on a box-like object, it can also be extended to two or more faces of the box-like object. The RFID inlay can be utilized on a round object, and the inlay can cover part of or all of the entire circumference of the round object. Accordingly, the disclosed RFID inlays can be written to and read from more than one direction.

In addition, embodiments of the invention also include RFID inlays constructed such that inlays on adjacent objects do not touch or oppose one another, even when their attached objects are in very close proximity to or in contact with one another.

### BRIEF DESCRIPTION OF THE DRAWINGS

FIG. 1A shows an object with a label having a conventional RFID inlay;

FIG. 1B shows the object label of FIG. 1A having a conventional RFID inlay;

FIG. 2A shows an object label having an RFID inlay in accordance with a first exemplary embodiment of the invention;

FIG. 2B shows two side-by-side adjacent objects each utilizing the RFID inlay illustrated in FIG. 2A;

FIG. 2C shows an array of objects each utilizing the RFID inlay illustrated in FIG. 2A;

FIG. 2D shows another object label having an RFID inlay in accordance with a modification of the first exemplary embodiment of the invention;

FIG. 2E shows another array of objects each utilizing the RFID inlay illustrated in FIG. 2A;

FIG. 3A shows an object label having an RFID inlay in accordance with a second exemplary embodiment of the invention;

FIG. 3B shows another object label having an RFID inlay in accordance with a modification of the second exemplary embodiment of the invention;

FIG. 4A shows an object label having an RFID inlay in accordance with a third exemplary embodiment of the invention;

FIG. 4B shows an array of objects each utilizing the RFID inlay illustrated in FIG. 4A;

FIG. 5A shows an object label having an RFID inlay in accordance with a fourth exemplary embodiment of the invention;

FIG. 5B shows another object label having an RFID inlay in accordance with a modification of the fourth exemplary embodiment of the invention;

FIG. 6 illustrates a roll of object labels, each having an RFID inlay in accordance with one of the disclosed embodiments of the invention; and

FIG. 7 illustrates a block diagram of a system including an RFID inlay constructed in accordance with one of the exemplary embodiments of the invention.

### DETAILED DESCRIPTION

Embodiments of the present invention will be described below where specific examples will be given with regard to the structural requirements, and the embodiments of the implementation of the invention corresponding thereto. In the following detailed description, reference is made to the accompanying figures which illustrate the described embodiments. The embodiments are described in sufficient detail to enable those skilled in the art to make and use the invention.

It is to be understood that additional embodiments may be used and that structural or operational changes to the embodiments herein described can be made without departing from the scope of the present invention. Accordingly, while exemplary embodiments of the invention will be described, other embodiments having the same or different structures are also within the invention. Despite the detail on several exemplary embodiments of this invention, this does not mean that all embodiments falling within the scope of the claims have been described in detail.

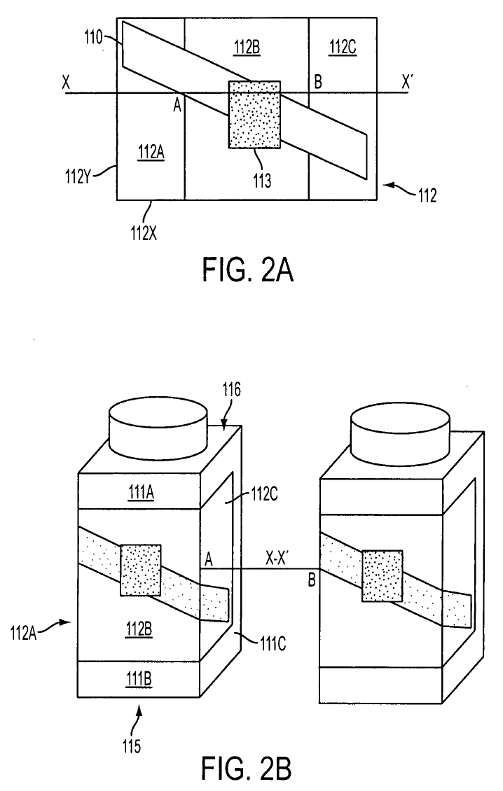

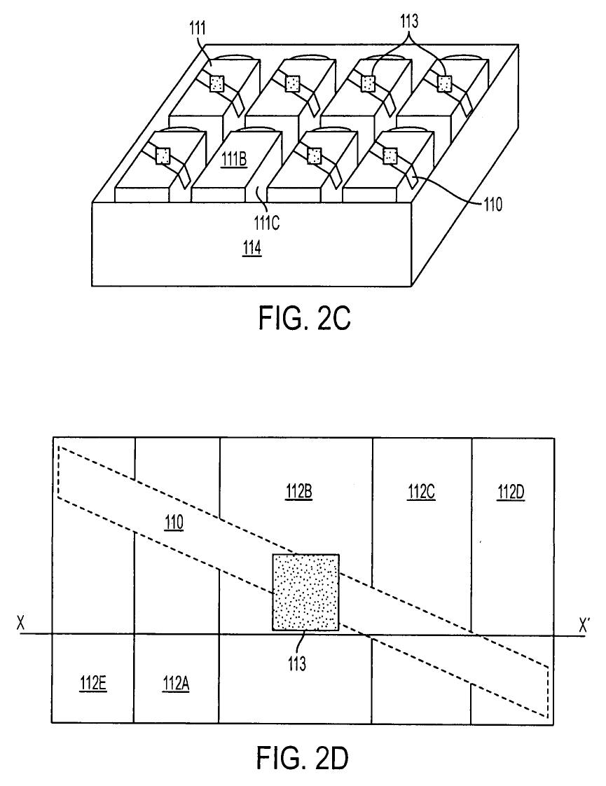

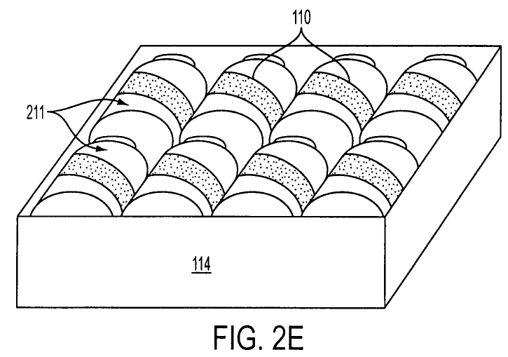

Now, with reference to the drawings, where like numerals represent like elements, FIG. 2-7 illustrate identification tags and system according to various exemplary embodiments of the invention. The identification tags include a means for communicating information related to an underlying object in a non-contact manner, more specifically, using RFID technology.

FIG. 2A shows an object label 112 having an RFID inlay 110 in accordance with a first exemplary embodiment of the invention. The RFID inlay 110 functions as an antenna for the integrated circuit chip 113 attached thereto. The integrated circuit chip 113 includes a memory for storing digital data, which can be an EEPROM or flash memory, or some other memory for storing digital data. The digital memory in the integrated circuit chip 113 can store any desired data, including but not limited to a product code or number. It should be understood that if an active RFID inlay is desirable, a power source for powering the chip 113 is also formed on the inlay 110. The inlay 110 portion extending from chip 113, which functions as an antenna, may be constructed as a flat plate-like antenna or as a coil loop antenna.

Although shown as a flat surface in FIG. 2A, it should be understood that the object label 112 contains multiple sections 112A-C that can be adhered to respective faces of an underlying object in application. FIG. 2B shows two side-by-side objects 111 each having an object label 112 with the three sections 112A-C respectively applied to a side 111A (not shown), front side 111B, and opposite side 111C of an object 111 in use. The object 111 also includes a back side (not shown), top portion 116, and base 115. As the RFID inlay 110 spans each of the three sections 112A-C of the object label 112, at least a portion of the RFID inlay 110 would be addressable from all three sides 11A-C of the underlying object 111.

FIGS. 2A and 2B each show a horizontal line X-X′, which runs parallel to the base 115 of the respective objects 111. In this configuration, the line X-X′ also runs parallel to a bottom edge 112X of the label 112 and orthogonal to a side edge 112Y of the label 112. Typically, the label 112 would be affixed to the object 111 with the bottom edge 112X parallel to a plane defined by the base 115.

In addition to providing a reference between the label 112 and base 115 of the object 111, line X-X′ helps illustrate the FIG. 2A configuration's ability to prevent the inlays 110 of side-by-side objects 111 from opposing or contacting one another. As shown in FIG. 2A, regardless of where it is placed, the horizontal line X-X′ does not intersect inlay 110 portions provided on “opposing” sections 112A and 112C, which are referred to as “opposing” because they adhere to opposing surfaces 111A and 111C of the object 111. In other words, while the line X-X′ sometimes intersects an inlay 110 portion on section 112A or 112C, it does not intersect inlay 110 portions on both sections 112 and 112C; and, consequently, does not intersect opposing inlay 110 portions adhered to the object 111.

Thus, one aspect of the structure and placement of the RFID inlays 110 of FIGS. 2A-C is that the inlay 110 is placed at an angle, with respect to the illustrated horizontal line X-X′ of the object label 112, such that inlay 110 is not provided on two opposing areas of the object label 112 that lie along the horizontal line X-X′ direction, i.e., not provided on both regions A and B in FIG. 2A. As shown in FIG. 2B, this in turn has the effect that, when side-by-side objects 111 are aligned and placed in close proximity or direct contact with one another, the objects 111 do not have inlay 110 portions provided on corresponding, opposing areas along the horizontal line X-X′ direction, e.g., there are not inlay 110 portions on both regions A and B of FIG. 2B. Consequently, if the adjacent objects 111 are aligned and sufficiently similar in size, shape, and orientation, the angled configuration of the RFID inlay 110 of FIG. 2A will prevent their respective RFID inlays 110 from touching or opposing one another, even if the two adjacent objects 111 are in contact with one another.

FIG. 2C illustrates an array of objects 111 in the form of individual product containers provided within a packaging or display container 114. Each object 111 has the RFID inlay 110 applied thereto. The RFID inlay 110 extends to both of the two faces 111B, 111C, as well as the third face 111A. Thus, when an RFID encoder/reader is in the vicinity of any of the three faces 111A-C of the objects 111, the RFID inlays 110 can receive signals, such that data can be written to and read from the integrated circuit chip 113 respectively coupled to each RFID inlay 110.

As shown in FIG. 2C the RFID inlay 110 can be attached to an underlying object 111 by use of an adhesive on the back surface of the inlay 110. Alternatively, as illustrated in FIG. 2B, the RFID inlay 110 can be formed on an object label 112, which is in turn applied to the object 111. The invention is in no way limited to the means for attaching the RFID inlay 110 to the object 111, but rather the inlay 110 can be secured to multiple faces of the object 111 by any known means.

As shown in FIG. 2D, the RFID inlay 110 may be further modified to extend onto fourth 112D and fifth 112E sections of the object label 112 to further wrap the inlay 110 around the object 111. When the inlay 110 of FIG. 2D is adhered to the object 111 of FIGS. 2B and 2C, with each of the five sections 112A-112E spanning over the four side edges of the object 111, the inlay 210 wraps more than 270 degrees around the object 111.

FIG. 2E shows an array of objects 211, in the form of individual product bottles, in a packaging or display container 114. As illustrated, each object 211 is round, and thus, individual faces of the object 211 cannot be easily differentiated. Each object 211 has an RFID inlay 110 constructed in accordance with a further modification of the first embodiment of the invention. The RFID inlay 110 is illustrated as a strip that spans a portion of or the entire circumference of the object 211. The RFID inlay 110 should span a sufficient portion of the circumference of the object such that it can receive RF waves from more than one direction. The RFID inlay 110 may cover the entire circumference of the object 211. The RFID inlay 110 functions as an antenna for the integrated circuit chip 113 formed thereon.

As illustrated, the RFID inlay 110 is directly adhered to the round objects 211. It should be understood, however, that the RFID inlays 110 could also be formed on object labels that are applied to the object. If an object label is used, the RFID inlay 110 of this embodiment could span more or less than the length of the label, so long as that when an RFID encoder/reader is in the vicinity of the objects 211, data can be written to and read from the integrated circuit chip 113 from multiple directions (i.e., the RFID encoder does not need to directly face the object 211). In addition, the RFID inlay 110 is constructed at an angle with respect to a horizontal plane of the underlying object 211 such that two adjacent inlays are not touching or opposing, even when the objects 211 are in close proximity or touching within a container 114.

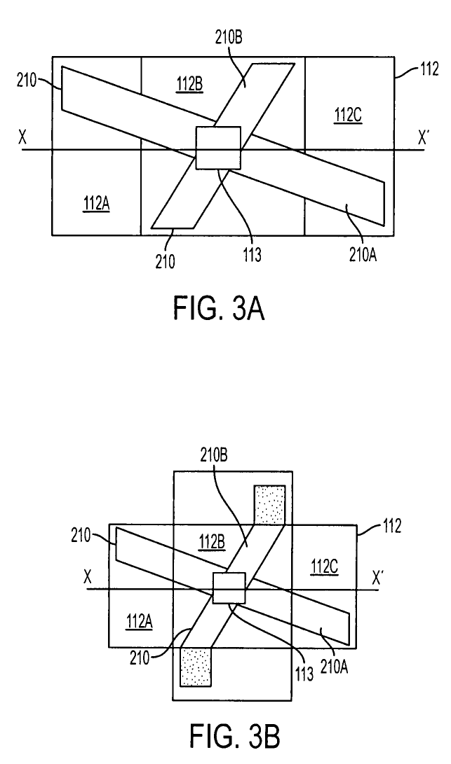

Accordingly, in operation of a RFID system employing the first embodiment of the invention, data can be read out from a plurality of objects 111 in close proximity to one another, from any one of three sides 11A-C or even fully around a round object 111, 211 with minimal interference. FIG. 3A shows another object label 112 having an RFID inlay 210, in accordance with a second embodiment of the invention, providing this capability. The RFID inlay 210 has a first strip 210A that is constructed at a first angle with respect to the horizontal line X-X′ of the object label 112. The first strip 210A spans all three sections of the object label 112A-C. A second strip 210B of the RFID inlay 210 is formed just on one section 112B of the object label 112. The second strip 210B is formed at a second angle with respect to vertical axis Y-Y′ of the object label 112. Both sections 210A and 210B of the RFID inlay 210 function as flat or loop radio antennas for transmission of data to and from the integrated circuit chip 113.

As shown, the RFID inlay 210 has two sections, shown as RFID antenna strips 210A, 210B. The first section 210A is formed to cover more than one face of an underlying object. The second section 210B is formed to increase the surface area of the antenna on at least one face of the underlying object. Thus, the RFID inlay 210 allows for reading or writing of the integrated circuit chip 113 from multiple directions, but may also have a preferential direction. It should be understood that the RFID inlay 210 is not limited to the rectangular strip structure as shown, but rather, can be formed in any desired shape or size.

In addition, when the object label 112 is attached to an object, or alternatively, when the RFID inlay 210 is itself adhered to an object, the angled configuration of the first RFID inlay strip 210A, that spans multiple sections of the inlay 210, will keep it from contacting or opposing an adjacent RFID inlay 210, even if the underlying objects are in very close proximity. Because the second strip 210B only covers the front face 112B of the object label 112, it can be formed at any desired angle, including zero degrees with respect to the horizontal without concern of touching an adjacent inlay. Moreover, the second strip 210B is not limited to the rectangular, strip-shaped design show, but rather, can be formed in any desired shape, having a surface area as large or as small as desired. As shown in FIG. 3B, the second RFID inlay strip 210B may be modified such that it can be folded over a top or bottom edge of the object 111 to provide additional coverage of the base 115 and top surface 116, thereby providing readability from the base 115 and top portion 116 of the object 111.

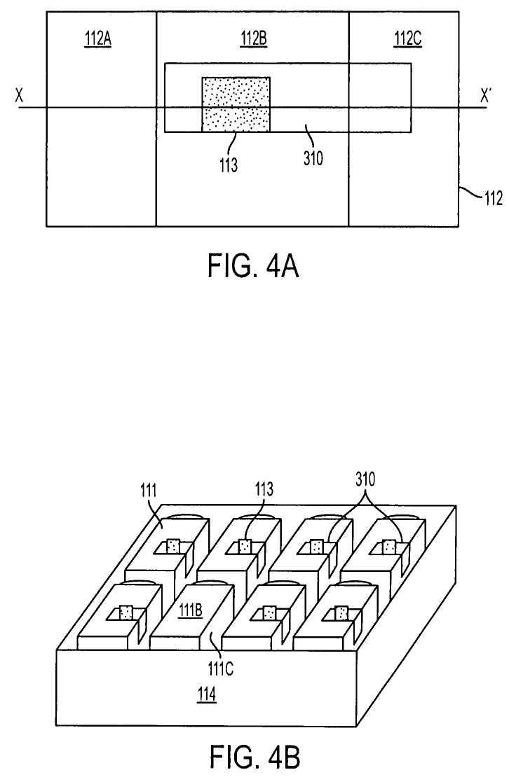

FIGS. 4A and 4B show an RFID inlay 310 in accordance with a third embodiment of the invention. FIG. 4A shows the RFID inlay 310 as formed on a three-section object label 112, having sections 112A-C for placement on respective three sides of an object. The RFID inlay 310, however, covers only two of the three sections 112A-C of the object label 112. As shown, the RFID inlay 310 is arranged to cover the front 112B and right section 112C of the object label 112, but it should be understood that the inlay 310 could also be constructed to cover the front 112B and left section 112A of the label 112. The RFID inlay 310 serves as an antenna for the integrated circuit chip 113, permitting reception and transmission of data to and from the chip 113 from multiple directions.

FIG. 4B shows an array of objects 111 in a container 114. Each object 111 has the RFID inlay 310 applied directly thereto, although the RFID inlays 310 could also be formed on object labels 112 that are applied to the object. As shown in FIG. 4B, the RFID inlay 310 spans the front face 111B and one side face 111C of each object 111. Thus, when an RFID encoder/reader is in the vicinity of either of these faces of the objects 111, data can be written to and read from the integrated circuit chip 113 respectively coupled to each RFID inlay 310.

In addition, because the inlay 310 covers two faces of an object 111B, 111C, two adjacent inlays 310 do not touch or oppose one another, despite the close proximity of each of the objects 111 in the container 114. Thus, the RFID inlay 310 does not need to be formed at an angle relative to the horizontal line X-X′, but can be if so desired. In operation, identifying information can be scanned from the objects 111 from at least two directions with minimal interference.

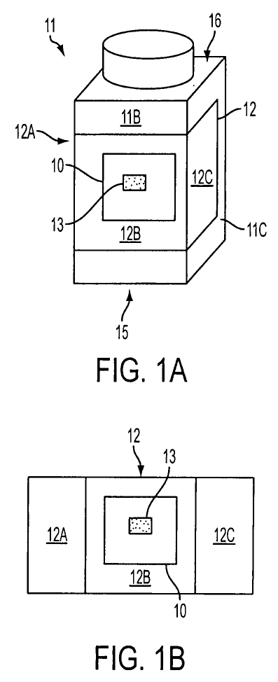

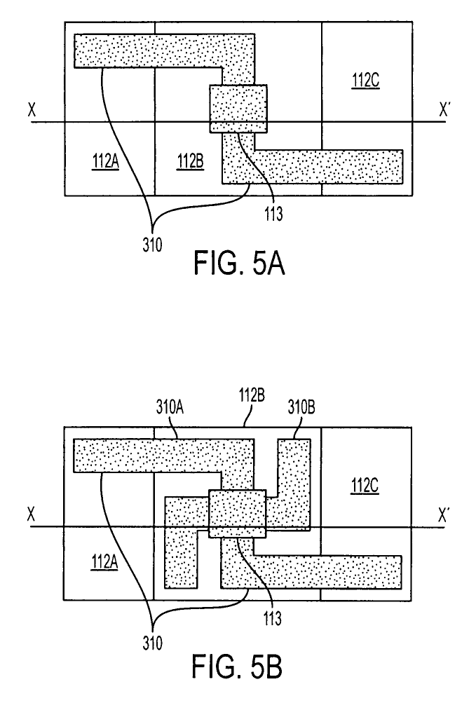

As shown in FIG. 5A, the RFID inlay 410 may be staggered, in a step-wise fashion over the three 112A-C or more sections of the object label 112, to cover more than two faces of the object 111. The staggering of the RFID inlay 410 may be provided in lieu of the angled inlay configurations of FIGS. 1-3. As with the angled configuration of the RFID inlay strips 110, 210 for FIGS. 1-3, the inlay strip 410 of FIG. 5A is positioned to prevent contact with an adjacent RFID inlay 410 of a neighboring object 111, even when the objects 111 are in very close proximity. In a further modification similar to the FIG. 3A embodiment, FIG. 5B shows a second inlay strip 410B which may be extended to just one portion of section 112B of the object label 112, such that two inlay strips 410A and 410B are provided for transmission and receipt of data.

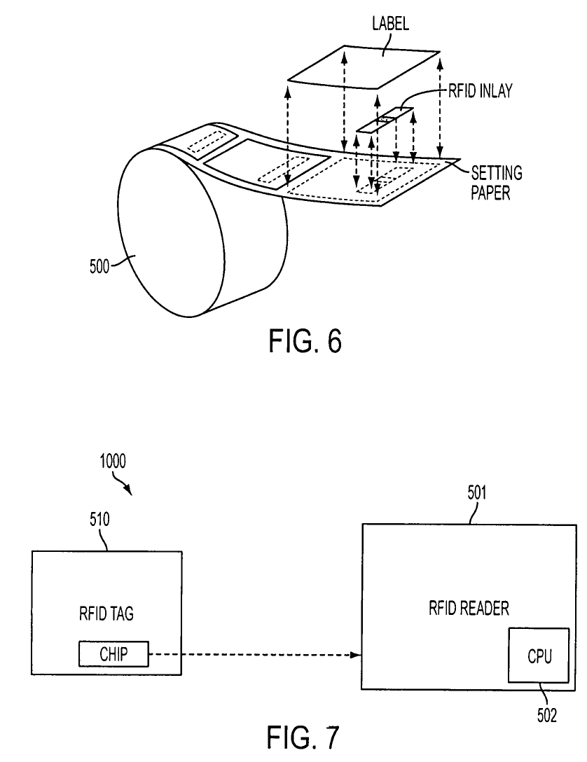

FIG. 6 shows a roll 500 of object labels having formed thereon RFID inlays 110, 210, 310, 410 constructed in accordance with one of the exemplary embodiments described above. An RFID-capable printer can be used to form the RFID inlays 110, 210, 310, 410 on the object labels, which are formed on setting paper, as shown in FIG. 5. Alternatively, as described above, the RFID inlays 110, 210, 310, 410 can be formed on a material substrate having an adhesive back-side for direct application onto an object.

FIG. 7 illustrates a block diagram of a system 1000 that includes an RFID tag 510, that can be constructed in accordance with any of the exemplary embodiments for RFID inlays 110, 210, 310, 410 described above. The RFID tag 510 includes an integrated circuit chip as well as a transponder antenna, which may be made of copper or aluminum plate or wire loop that is constructed into a circular, or some other, pattern around the chip. An encapsulating material, such as glass or polymer, may also be formed in a thin layer around the chip and transponder.

The system 1000 also includes an RFID reader 501, which can be of any size or shape, such as a portable, hand-held device. As shown, the RFID reader 501 includes a processor, CPU 502, which may be internal or external to the reading device, for processing data that is transmitted to or from RFID tag 510. For example, CPU 502 may be part of a host computer utilizing the RFID reader 501 as a peripheral device.

In operation of the system 1000, RFID reader 501 generates an RF field, generally covering a relatively short range. When the RFID tag 510 passes through the RF field generated by the RFID reader 510, the RFID tag's antenna picks up the RF field from the reader 501. In accordance with a preferred embodiment of operation, the RFID tag's antenna are sensitive to radio frequency waves in the range of the ultra low frequency band, preferably about 900 MHz. The RF waves picked up by the antenna provide energy to power up the chip in the RFID tag 510 and to transmit a response. The RFID reader 501 receives the response and decodes the data transmitted from the digital memory in the RFID tag 510. The decoded data can then be processed by the processor CPU 502.

The above description and drawings are only to be considered illustrative of exemplary embodiments which achieve the features and advantages of the invention. Modification of, and substitutions to, specific operating conditions and structures can be made without departing from the spirit and scope of the invention. For example, although shown and described as passive RFID inlays 110, 210, 310, 410, it should be understood that the invention can be employed with any type of non-contact communication system. Accordingly, the invention is not to be considered as being limited by the foregoing description and drawings, but is only limited by the scope of the appended claims.

What is claimed as new and desired to be protected by Letters Patent of the United States is:

1. A method of attaching a radio frequency identification device to an object, comprising:
attaching an antenna inlay to a circuit including a memory device;
providing the antenna inlay and circuit on the object; and
extending the antenna inlay at least partially around the object, wherein no two areas of the antenna inlay are intersected by a line orthogonal thereto.

2. The method of claim 1, wherein the object has a cylindrical shape.

3. The method of claim 1, wherein the antenna inlay extends in two portions from the circuit.

4. The method of claim 3, wherein one of the inlay portions extends over at least one edge of the object and the other inlay portion does not extend over any edges of the object.

5. The method of claim 3, wherein the antenna inlay extends in another two portions from another two opposing sides of the circuit.

6. The method of claim 3, wherein the two inlay portions each extend over a respective edge of the object.

7. The method of claim 6, wherein the two inlay portions each extend at respective angles, other than zero and ninety degrees, from a plane defined by a base of the object.

8. The method of claim 6, wherein the two inlay portions each extend at zero and ninety degrees from a plane defined by a base of the object.

9. The method of claim 6, wherein the two inlay portions extend over a total of at least three edges of the object.

10. The method of claim 9, wherein the two inlay portions extend over a total of four edges of the object.

11. The method of claim 3, wherein one of the inlay portions extends over a top or base edge of the object.

12. The method of claim 1, wherein the antenna inlay forms part of a label adhered to the object.

13. The method of claim 1, wherein the antenna inlay is directly adhered to the object.

14. An object label for radio frequency identification, comprising:
a flexible substrate having a surface;
a reference line for aligning the substrate on the object;
a circuit device supported by the substrate; and
an antenna inlay supported by the substrate and connected to the circuit device, the antenna inlay extending from the circuit device at an angle greater than zero degrees from the horizontal line.

15. The label of claim 14, wherein the substrate is sized to wrap around at least one edge of an object, and wherein the antenna inlay is arranged on the substrate such that the antenna inlay extends over at least two faces of the object to which the label is attached.

16. The label of claim 14, wherein, when the substrate and antenna inlay are wrapped at least partially around the object, no two areas of the antenna inlay are intersected by a line orthogonal thereto.

17. The label of claim 14, wherein the reference line is a bottom edge of the label.

18. The label of claim 14, wherein the object has a cylindrical shape.

19. The label of claim 14, wherein the antenna inlay extends in two portions from the circuit.

20. The label of claim 19, wherein one of the inlay portions extends over at least one edge of the object and the other inlay portion does not extend over any edges of the object.

21. The label of claim 19, wherein the antenna inlay extends in another two portions from another two opposing sides of the circuit.

22. The label of claim 19, wherein, when the substrate is aligned and wrapped at least partially around the object, the two inlay portions each extend over a respective edge of the object.

23. The label of claim 22, wherein, when the substrate is aligned and wrapped at least partially around the object, the two inlay portions each extend at respective angles, other than zero and ninety degrees, from a plane defined by a base of the object.

24. The label of claim 22, wherein, when the substrate is aligned and wrapped at least partially around the object, the two inlay portions each extend at zero and ninety degrees from a plane defined by a base of the object.

25. The label of claim 22, wherein, when the substrate is aligned and wrapped at least partially around the object, the two inlay portions extend over a total of at least three edges of the object.

26. The label of claim 25, wherein, when the substrate is aligned and wrapped at least partially around the object, the two inlay portions extend over a total of four edges of the object.

27. The label of claim 19, wherein, when the substrate is aligned and wrapped at least partially around the object, one of the inlay portions extends over a top or base edge of the object.

28. A radio frequency identification system, comprising:
an array of objects each comprising a base, at least one face, and a radio frequency identification device, the objects being arranged with their radio frequency identification devices each aligned and facing a same direction,
wherein the radio frequency identification device of each object includes a circuit device for storing data and an antenna inlay connected to the circuit device, the antenna inlay being provided on and at least partially around the object, and
wherein the antenna inlays of adjacent objects do not directly oppose one another.

29. The system of claim 28, wherein the objects have a cylindrical shape.

30. The system of claim 28, wherein, for each object, the antenna inlay extends in two portions from the circuit device.

31. The system of claim 30, wherein, for each object, one of the inlay portions extends over at least one edge of the object and the other inlay portion does not extend over any edges of the object.

32. The system of claim 30, wherein, for each object, the antenna inlay extends in another two portions from another two opposing sides of the circuit.

33. The system of claim 30, wherein, for each object, the two inlay portions each extend over a respective edge of the object.

34. The system of claim 33, wherein, for each object, the two inlay portions each extend at respective angles, other than zero and ninety degrees, from a plane defined by a base of the object.

35. The system of claim 33, wherein, for each object, the two inlay portions each extend at zero and ninety degrees from a plane defined by a base of the object.

36. The system of claim 33, wherein, for each object, the two inlay portions extend over a total of at least three edges of the object.

37. The system of claim 36, wherein, for each object, the two inlay portions extend over a total of four edges of the object.

38. The system of claim 30, wherein, for each object, one of the inlay portions extends over a top or base edge of the object.

39. The system of claim 28, wherein, for each object, the antenna inlay forms part of a label adhered thereto.

40. The system of claim 28, wherein the antenna inlays are directly adhered to the objects.
